(19) United States
(12) Patent Application Publication
(10) Pub. No.: US 2026/0049016 A1
(43) Pub. Date: Feb. 19, 2026

(54) ANAEROBIC/AEROBIC SYSTEM WITH AMMONIA REMOVAL STEP AND RECYCLE FOR TREATING WASTEWATER

(71) Applicant: Evoqua Water Technologies LLC, Pittsburgh, PA (US)

(72) Inventors: Daniel Bertoldo, Fredericton (CA); Shannon Grant, New Maryland (CA); Ke Xie, Fredericton (CA); Alex McDonald, Missouri City, TX (US)

(21) Appl. No.: 19/102,898

(22) PCT Filed: Jul. 11, 2023
(86) PCT No.: PCT/US2023/027362

§ 371 Date: Feb. 11, 2025

Related U.S. Application Data
(60) Provisional application No. 63/359,995, filed on Jul. 11, 2022.

(51) Int. Cl. C02F 9/00; C02F 1/00; C02F 1/20; C02F 1/66; C02F 3/12; C02F 3/30; C02F 101/16

(52) U.S. Cl. CPC C02F 9/00; C02F 1/008; C02F 1/20; C02F 1/66; C02F 3/1268; C02F 3/30; C02F 2101/16; C02F 2209/14; C02F 2209/40; C02F 2301/046

(57) ABSTRACT

A method of treating a wastewater having an ammonia concentration that is toxic to anaerobic bacteria includes introducing the wastewater into an anaerobic biological treatment vessel to produce a digestate, introducing a portion of the digestate into an ammonia removal sub-system to produce an effluent having a lower ammonia concentration than the digestate, diluting the wastewater introduced into the anaerobic biological treatment vessel by introducing a portion of the effluent from the ammonia removal sub-system into the anaerobic biological treatment vessel with the wastewater, and regulating the flow rate of the portion of the effluent from the ammonia removal sub-system to cause the portion of the effluent to be introduced into the anaerobic biological treatment vessel in an amount sufficient to form an anaerobic biological treatment vessel influent having an ammonia concentration lower than an ammonia concentration that is toxic to anaerobic bacteria in the anaerobic biological treatment vessel.

### FIELD OF TECHNOLOGY

Aspects and embodiments disclosed herein relate to devices and methods for treating wastewater to remove toxic and/or harmful components such as ammonia.

### SUMMARY

In accordance with one aspect, there is provided a method of treating a wastewater having an ammonia concentration that is toxic to anaerobic bacteria. The method comprises introducing the wastewater into an anaerobic biological treatment vessel to produce a digestate from the wastewater, introducing the digestate from the anaerobic biological treatment vessel into an ammonia removal sub-system to separate the digestate into removed ammonia and an effluent having a lower ammonia concentration than the digestate, introducing a first portion of the effluent from the ammonia removal sub-system into an aerobic biological treatment vessel, diluting the wastewater introduced into the anaerobic biological treatment vessel by introducing a second portion of the effluent from the ammonia removal sub-system into one of a point upstream of the anaerobic biological treatment vessel and into the anaerobic biological treatment vessel with the wastewater, and regulating relative flow rates of the first and second portions of the effluent from the ammonia removal sub-system to cause the second portion of the effluent to be introduced into the anaerobic biological treatment vessel in an amount sufficient to mix with the wastewater introduced into the anaerobic biological treatment vessel and form an anaerobic biological treatment vessel influent having an ammonia concentration less than that of the wastewater and lower than an ammonia concentration that is toxic to anaerobic bacteria in the anacrobic biological treatment vessel.

In some embodiments, the method comprises mixing a sufficient amount of the second portion of the effluent from the ammonia removal sub-system with the wastewater introduced into the anaerobic biological treatment vessel to form the influent with an ammonia concentration of less than about 2000 mg/L.

In some embodiments, the method further comprises measuring a concentration of ammonia in the wastewater.

In some embodiments, the method further comprises measuring a concentration of ammonia in the effluent from the ammonia removal sub-system.

In some embodiments, the method further comprises selecting the relative flow rates of the first and second portions of the effluent from the ammonia removal sub-system based on at least one of the concentration of ammonia in the wastewater and the concentration of ammonia in the effluent from the ammonia removal sub-system.

In some embodiments, the method further comprises introducing caustic into the digestate from the anaerobic biological treatment vessel upstream of the ammonia removal sub-system.

In some embodiments, the method further comprises introducing a pH adjustment agent into one of the second portion of the effluent from the second outlet of the ammonia removal sub-system and the wastewater upstream of the inlet of the anaerobic biological treatment vessel in an amount and concentration sufficient to maintain a pH of aqueous solution within the anacrobic biological treatment vessel between about 6.6 and about 8.0.

In some embodiments, the method further comprises obtaining the wastewater from a blue hydrogen production plant.

In accordance with another aspect, there is provided an apparatus for treating a wastewater having an ammonia concentration that is toxic to anaerobic bacteria. The system comprises an anaerobic biological treatment vessel having an inlet configured to receive the wastewater and an outlet configured to output digestate from the anaerobic biological treatment vessel, an ammonia removal sub-system having an inlet configured to receive the digestate from the outlet of the anaerobic biological treatment vessel, a removed ammonia outlet, and an effluent outlet configured to output effluent from the ammonia removal sub-system, an aerobic biological treatment vessel having an inlet configured to receive a first portion of the effluent from the effluent outlet of the ammonia removal sub-system, a recycle line configured to direct a second portion of the effluent from the effluent outlet of the ammonia removal sub-system to one of a point upstream of the anacrobic biological treatment vessel and into the anaerobic biological treatment vessel, and a controller configured to regulate relative flow rates of the first and second portions of the effluent from the ammonia removal sub-system and to cause the second portion of the effluent to be introduced into the anacrobic biological treatment vessel in an amount sufficient to mix with wastewater introduced into the anaerobic biological treatment vessel and form an anaerobic biological treatment vessel influent having an ammonia concentration that is less than that of the wastewater and lower than an ammonia concentration that is toxic to anaerobic bacteria in the anaerobic biological treatment vessel.

In some embodiments, the controller is configured to cause the sufficient amount of the second portion of the effluent from the outlet of the ammonia removal sub-system to be mixed with the wastewater introduced into the anaerobic biological treatment vessel to form the influent with an ammonia concentration of less than about 2000 mg/L.

In some embodiments, the system further comprises an ammonia concentration sensor configured to measure a concentration of ammonia in the wastewater and provide an indication of the concentration of ammonia in the wastewater to the controller.

In some embodiments, the controller is further configured to determine the relative flow rates of the first and second portions of the effluent from the ammonia removal sub-system based at least in part on the indication of the concentration of ammonia in the wastewater.

In some embodiments, the system further comprises a second ammonia concentration sensor configured to measure a concentration of ammonia in the effluent from the ammonia removal sub-system and provide an indication of the concentration of ammonia in the effluent from the ammonia removal sub-system to the controller.

In some embodiments, the controller is further configured to determine the relative flow rates of the first and second portions of the effluent from the ammonia removal sub-system based at least in part on the indication of the concentration of ammonia in the wastewater and the indication of the concentration of ammonia in the effluent from the ammonia removal sub-system.

In some embodiments, the controller is further configured to set the relative flow rates of the first and second portions of the effluent from the ammonia removal sub-system such that a ratio between an amount of the second portion of the effluent from the ammonia removal sub-system and an amount of influent wastewater introduced into the anaerobic biological treatment vessel is between 0.5 and 10.

In some embodiments, the ammonia removal sub-system includes an ammonia stripper.

In some embodiments, the system further comprises a source of caustic configured to introduce caustic into the digestate from the outlet of the anaerobic biological treatment vessel upstream of the inlet of the ammonia removal sub-system.

In some embodiments, the system further comprises a source of pH adjustment agent configured to introduce the pH adjustment agent into one of the second portion of the effluent from the outlet of the ammonia removal sub-system and/or the wastewater upstream of the inlet of the anaerobic biological treatment vessel.

In some embodiments, the controller is further configured to regulate addition of the pH adjustment agent into the one of the second portion of the effluent from the outlet of the ammonia removal sub-system or the wastewater to maintain a pH of aqueous solution within the anaerobic biological treatment vessel between about 6.6 and about 8.0.

In some embodiments, the system further comprises an equalization tank upstream of the anaerobic biological treatment vessel.

In some embodiments, the system further comprises a return activated sludge recycle line configured to recycle activated sludge from a sludge outlet of the aerobic biological treatment vessel to the inlet of the aerobic biological treatment vessel.

In some embodiments, the system further comprises a return activated sludge recycle line configured to recycle activated sludge from a sludge outlet of the aerobic biological treatment vessel to the inlet of the anaerobic biological treatment vessel.

In some embodiments, the aerobic biological treatment vessel includes a membrane bioreactor.

### BRIEF DESCRIPTION OF THE DRAWINGS

The accompanying drawings are not drawn to scale. In the drawings, each identical or nearly identical component that is illustrated in the various figures is represented by a like numeral. For purposes of clarity, not every component may be labeled in every drawing. In the drawings:

FIG. 1 illustrates one example of a system for treating wastewater; and

FIG. 2 illustrates another example of a system for treating wastewater.

### DETAILED DESCRIPTION

Ammonia is one of the largest chemical products in the world and plays an important role in the global economy. Ammonia is traditionally used in the production of fertilizer, reduction of NOx, and as a chemical precursor. As an ideal hydrogen carrier, ammonia can also be regarded as an energy storage medium, especially for renewable energy where it can be cracked into hydrogen and nitrogen so that the hydrogen can be combusted or used in a fuel cell or ammonia could be used directly for combustion.

Blue hydrogen is hydrogen produced from natural gas with a process of steam methane reforming, where natural gas is mixed with very hot steam and a catalyst. A chemical reaction occurs creating hydrogen and carbon monoxide.

Green hydrogen is hydrogen produced from an electrolytic process where water is split into hydrogen and oxygen. Depending on the energy source for the electrolytic process, hydrogen can be produced carbon-free.

In wastewater treatment plants, one of the available unit processes may involve treatment of the wastewater with anaerobic microorganisms. Even though an anaerobic process tank may be open, in the absence of added oxygen, the prevailing conditions in the water in the tank may be anaerobic. Anaerobic microorganisms populate the tank and convert biologically degradable material in the wastewater primarily into water and biogas, which is primarily carbon dioxide and methane.

In membrane biorcactors, solid-liquid separation of the degrading or degraded wastewater is performed through a membrane filter. The membrane filter may be immersed directly into a process tank or may be immersed in a separate tank with an inlet from a process tank and an outlet back to the same or another process tank. The membranes are typically in the microfiltration or ultrafiltration range. A flux of permeate (filtered water) may be drawn through the membranes by suction applied to an inside volume of the membrane filter.

In one embodiment, an anaerobic biological treatment process and a membrane bioreactor are used to treat the wastewater from a blue hydrogen production plant. One issue is that the levels of ammonia in the wastewater from blue hydrogen production plant can be toxic to the anaerobic bacteria present in an anaerobic biological treatment vessel (also referred to herein as an anaerobic digester or anaerobic biological treatment system) used to perform the anaerobic biological treatment process. The ammonia concentration in the wastewater may be reduced by diluting the wastewater with dilution water recycled from the post-anaerobically treated ammonia removal process in an amount sufficient to decrease the ammonia concentration in the influent fluid stream to the anaerobic biological treatment system below the inhibitory threshold to anaerobic bacteria.

Aspects and embodiments disclosed herein utilize anaerobic digestion for treatment of Blue Hydrogen wastewater, in combination with a post-anaerobic ammonia stripping step, with adequate recycle from the post-anaerobic ammonia stripping step to the influent of the anacrobic digester, such that ammonia toxicity/inhibition is avoided. Stripped ammonia can be recovered for beneficial use. Further aspects and embodiments disclosed pertain to the reducing the ammonia toxicity by one or more unit operations that strip ammonia or by diluting to avoid toxic concentration levels.

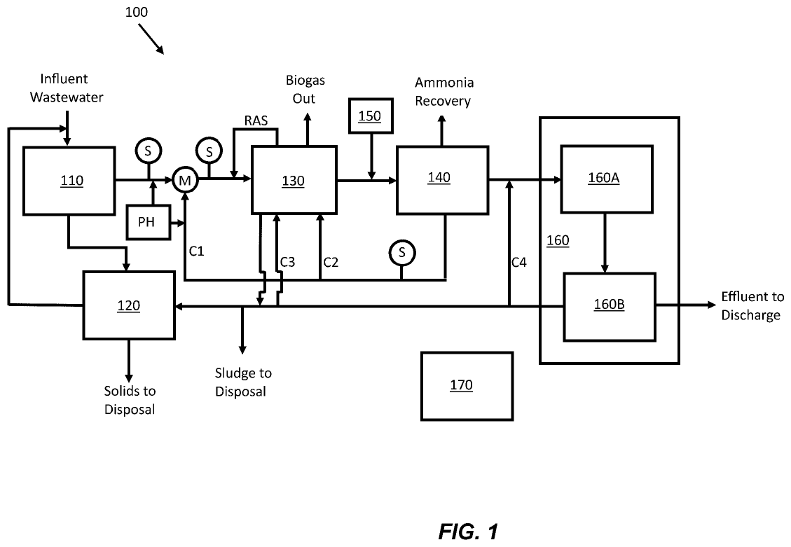

Referring to FIG. 1, a system 100 is illustrated for treating wastewater from Blue Hydrogen production. The system 100 includes an initial solids/liquid separation unit operation 110, for example, an equalization tank or clarifier. Settled solids from the solids/liquid separation unit operation 110 may be sent to a dewatering unit operation 120, for example, a filter press or other dewatering unit known in the art, which may separate the settled solids into dewatered solids that may be disposed of and a low solids liquid that may be recycled back to, for example, a point upstream of the solids/liquid separation unit operation 110 or into an inlet of the solids/liquid separation unit operation 110.

Supernatant from the solids/liquid separation unit operation 110 that has a lower solids concentration than the influent wastewater into the solids/liquid separation unit operation 110, that may still be considered wastewater, is directed into an inlet of an anaerobic biological treatment system 130, for example a vessel including anaerobic bacteria that is maintained under conditions suitable for the anaerobic bacteria to digest or break down at least a portion of the solids remaining in the supernatant from the solids/liquid separation unit operation 110 (e.g., about 95° F. and a pH of between 6.0 and 8.0 or between 6.6 and 8.0). The anacrobic biological treatment system 130 may break down solids remaining in the supernatant from the solids/liquid separation unit operation 110 into biogas and water and may form anaerobically digested sludge. The biogas may be vented to atmosphere, burned, for example, for energy production, or collected for utilization by others. The anaerobically digested sludge may be separated into different streams which may be recycled to the anacrobic biological treatment system 130 as anaerobically digested return activated sludge (RAS), dewatered along with settled solids from the solids/liquid separation unit operation 110 in the dewatering unit operation 120, or directed out of the system 100 for disposal.

Digestate from the anaerobic biological treatment system 130 having a lower solids concentration than the supernatant from the solids/liquid separation unit operation 110 is removed through an outlet of the anaerobic biological treatment system 130 and directed into an inlet of an ammonia recovery/removal sub-system 140, for example, an ammonia stripper such as an ammonia treatment system available from Hyperion Water Technologies or a Liqui-Cel™ membrane contactor available from the 3M Company. Up to 80% to 90% of the ammonia in the digestate may be removed in the ammonia recovery/removal sub-system 140 as either liquid ammonia or an ammonia salt such as ammonia sulfate and may be recovered and utilized, for example, for the production of fertilizer or other useful chemicals. The ammonia recovery/removal sub-system 140 outputs an effluent liquid from which ammonia has been removed. A first portion of effluent liquid from which ammonia has been removed in the ammonia recovery/removal system 140 may leave the ammonia recovery/removal sub-system 140 from a first outlet and be sent to downstream unit operations for further treatment. A second portion of the effluent liquid may leave the ammonia recovery/removal sub-system 140 from a second outlet and be recycled back to upstream unit operations of the system 100. In some embodiments, the first and second portions of the effluent liquid may leave the ammonia recovery/removal sub-system 140 from the same outlet and be split into different streams downstream of the outlet from the ammonia recovery/removal sub-system 140.

The ammonia removal step will typically include addition of caustic to the digestate from the anaerobic biological treatment system 130 to increase the pH so that the ammonia can be more easily stripped from the digestate, e.g., pH in a range of from 10.8 to 11.5. The source of caustic may be internal to the ammonia recovery/removal sub-system 140 or may be an external source of caustic 150, e.g., lime, disposed fluidically between the outlet of the anacrobic biological treatment system 130 and the inlet of the ammonia recovery/removal sub-system 140. Stripping towers, counter or cross-flow, using air as solvent gas may be used. Ammonia removal using stripping concepts is typically more cost effective and less energy intensive than conventional biological nitrification. By placing the ammonia recovery/removal sub-system 140 after the anaerobic biological treatment system 130, most of the organic acids have been removed anaerobically, thereby significantly decreasing the caustic chemical addition requirements.

Blue Hydrogen production wastewater typically has high chemical oxygen demand (COD), biological oxygen demand (BOD), and ammonia concentrations. The high biodegradable COD content (19,400 mg/l in one non-limiting example) makes anaerobic treatment an appropriate and cost-effective approach to treating the wastewater. However, the high ammonia concentration in the wastewater (5300 mg/l in one non-limiting example) also makes the wastewater toxic to anaerobic bacteria that would be present in the anacrobic biological treatment system 130, unless the ammonia concentration can be decreased in the influent to the anaerobic biological treatment system 130 to less than about 2000 mg/l. Therefore, the anaerobic digester influent/supernatant from the solids/liquid separation unit operation 110 may be diluted with enough of the effluent liquid from which ammonia has been removed in the ammonia recovery/removal sub-system 140 such that the ammonia concentration in liquid within the anaerobic biological treatment system 130 is maintained at less than the target setpoint to avoid ammonia toxicity/inhibition. The portion of the effluent liquid from which ammonia has been removed in the ammonia recovery/removal sub-system 140 (the second portion) may be returned through one or more dilution recycle conduits C1 and/or C2 to a point upstream of the anaerobic biological treatment system 130 or directly into the anaerobic biological treatment system 130 for mixing with the supernatant from the solids/liquid separation unit operation 110 to be treated in the anaerobic biological treatment system 130. A static mixer M may be utilized to facilitate thorough mixing of the second portion of the effluent liquid from which ammonia has been removed in the ammonia recovery/removal sub-system 140 and the supernatant from the solids/liquid separation unit operation 110.

In some embodiments, the effluent liquid from which ammonia has been removed in the ammonia recovery/removal system 140 may have an undesirably high pH due to the addition of caustic in the ammonia removal process. Accordingly, a source of pH adjustment agent PH, for example, an acid such as sulfuric or hydrochloric acid may be provided to adjust or maintain the pH of the mixed liquid to be treated in the anaerobic biological treatment system 130 to between about 6.6 and 8.0. The source of pH adjustment agent may be provided and configured to introduce the pH adjustment agent into one or both of the second portion of the effluent from an outlet of the ammonia recovery/removal sub-system 140 and/or the wastewater upstream of the inlet of the anaerobic biological treatment system 130.

The first portion of the effluent liquid from which ammonia has been removed in the ammonia recovery/removal sub-system 140 (the portion not used for diluting the feed stream into the anaerobic biological treatment system 130) is directed into an aerobic biological treatment vessel or system 160 having an inlet configured to receive the first portion of the effluent from the effluent outlet of the ammonia recovery/removal sub-system 140.

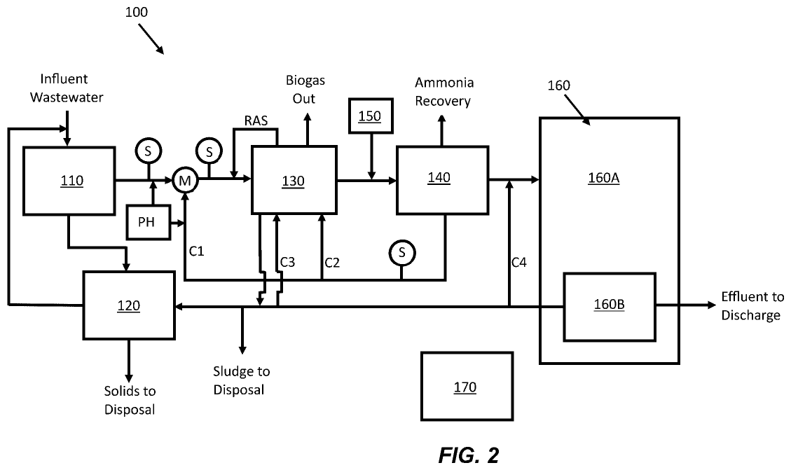

The aerobic biological treatment system 160 may be a membrane bioreactor. The membrane filtration portion of the membrane bioreactor may be in a vessel 160B that is separate from but fluidically connected downstream of a vessel 160A used to perform the aerobic biological treatment of the first portion of the effluent from the ammonia recovery/removal sub-system 140 as shown in FIG. 1, or may be included within the vessel 160A as illustrated in FIG. 2.

The aerobic biological treatment vessel 160 may produce a reduced solids effluent from the first portion of the effluent liquid from the ammonia recovery/removal sub-system 140 and an aerobic sludge. The effluent liquid produced in the aerobic biological treatment vessel 160 may have a lower suspended solids content than the first portion of the effluent liquid from the ammonia recovery/removal sub-system 140 and may have sufficiently low suspended solids, BOD, COD, ammonia, or other contaminants such that it may be suitable for discharge to the environment. The aerobic sludge produced in the aerobic biological treatment vessel 160 may be recycled as aerobic RAS to inlets of either or both of the anaerobic biological treatment system 130 or the aerobic biological treatment vessel 160, for example, through sludge recycle conduits C3 and/or C4.

It is to be appreciated that the system 100 may include numerous pumps, valves, or other forms of fluid flow control apparatus that are omitted from the figures for the purpose of clarity. For example, valves may be provided on the different outlets of the ammonia recovery/removal sub-system 140 to control the relative flow rates of the first and second portions of the effluent from the ammonia recovery/removal sub-system 140.

The system 100 may include various sensors and a controller 170 to control operation of the different unit operations. For example, the controller may be configured to regulate relative flow rates of the first and second portions of the effluent from the ammonia recovery/removal sub-system 140 and to cause the second portion of the effluent to be introduced into the anaerobic biological treatment system 130 in an amount sufficient to mix with wastewater (e.g., the supernatant from the solids/liquid separation unit operation 110) introduced into the anaerobic biological treatment system 130 and form an anaerobic biological treatment vessel influent having an ammonia concentration that is less than that of the wastewater and lower than an ammonia concentration that is toxic to anaerobic bacteria in the anaerobic biological treatment system 130. The controller 170 may, for example, be configured to cause the sufficient amount of the second portion of the effluent from the outlet of the ammonia recovery/removal sub-system 140 to be mixed with the wastewater introduced into the anaerobic biological treatment system 130 to form the influent to the anaerobic biological treatment system 130 with an ammonia concentration of less than about 2000 mg/L, in some embodiments, less than about 30 mg/L.

The system 100 may include an ammonia concentration sensor S configured to measure a concentration of ammonia in the wastewater (e.g., the supernatant from the solids/liquid separation unit operation 110) and provide an indication of the concentration of ammonia in the wastewater to the controller 170. The controller 170 may be further configured to determine and set the relative flow rates of the first and second portions of the effluent from the ammonia recovery/removal sub-system 140 based at least in part on the indication of the concentration of ammonia in the wastewater.

The system 100 may include a second ammonia concentration sensor S configured to measure a concentration of ammonia in the effluent from the ammonia recovery/removal sub-system 140 and provide an indication of the concentration of ammonia in the effluent from the ammonia recovery/removal sub-system 140 to the controller 170. The controller 170 may be further configured to determine and set the relative flow rates of the first and second portions of the effluent from the ammonia recovery/removal sub-system 140 based at least in part on the indication of the concentration of ammonia in the wastewater and the indication of the concentration of ammonia in the effluent from the ammonia recovery/removal sub-system 140. Additionally or alternatively, the controller 170 may be further configured to set the relative flow rates of the first and second portions of the effluent from the ammonia removal sub-system such that a ratio between an amount of the second portion of the effluent from the ammonia removal sub-system and an amount of influent wastewater introduced into the anaerobic biological treatment vessel is between 0.5 and 10.

A third ammonia concentration sensor S may be provided downstream of the point of addition of the effluent from the ammonia recovery/removal sub-system 140 into the conduit leading into the anaerobic biological treatment system 130 and upstream of the inlet of the anaerobic biological treatment system 130 to verify that the ammonia concentration of the aqueous stream formed from the mixed wastewater and effluent from the ammonia recovery/removal sub-system 140 to be introduced into the anaerobic biological treatment system 130 is at an acceptable level. This sensor S may additionally or alternatively include a pH probe to measure the pH of the aqueous stream to be introduced into the anaerobic biological treatment system 130 and to provide feedback regarding same to the controller 170 so that it can modulate addition of pH adjustment agent from the pH adjustment agent source PH and maintain a desired pH level in the liquid in the anaerobic biological treatment system 130.

The controller 170 may be further configured to regulate addition of the pH adjustment agent into the one of the second portion of the effluent from the outlet of the ammonia recovery/removal sub-system 140 or the wastewater (e.g., the supernatant from the solids/liquid separation unit operation 110) to maintain the pH of aqueous solution within the anaerobic biological treatment system 130 between about 6.6 and about 8.0.

In some embodiments, the controller 170 is generally constructed and arranged to control operation of any or all components of the system 100. In some embodiments, the controller 170 is configured to receive measurements from any or all of the sensors S. The controller 170 is in communication with one or more unit operations of the system, for example, any one or more of the solids/liquid separation unit operation 110, dewatering unit operation 120, anacrobic biological treatment system 130, ammonia recovery/removal sub-system 140 and associated valves on the outlets of the ammonia recovery/removal sub-system 140, source of caustic 150, the aerobic biological treatment vessel 160, source of pH adjustment agent PH, or any other component or unit operation of the system 100. Communication lines between the sensors S and controller 170 and between the controller 170 and system components are not illustrated for the sake of clarity. Further it is to be understood that the system 100 would typically include multiple pumps, valves, flow regulators, etc. in communication with the controller 170 to control the flow rates of any fluids through any portions of the system 100. These pumps, valves, flow regulators, etc. are also omitted from the figures for the sake of clarity.

In some embodiments, the output from any one or more of the sensors S is transmitted to the controller 170 and is used by the controller 170 to determine whether to adjust one or more unit operations or components of the system, for example, to achieve desired levels of contaminants, flow rate of wastewater or effluent into or out of any unit operation, one or more quality indicators, for example, concentration of ammonia and pH of fluid introduced into the anaerobic biological treatment system 130, or any other property of wastewater undergoing treatment in any portion of the system 100.

The controller 170 may be implemented using one or more computer systems. The computer system may be, for example, a general-purpose computer such as those based on an Intel CORE®-type processor, an Intel XEON®-type processor, an Intel CELERON®-type processor, an AMD FX-type processor, an AMD RYZEN®-type processor, an AMD EPYC®-type processor, and AMD R-series or G-series processor, or any other type of processor or combinations thereof. Alternatively, the computer system may include programmable logic controllers (PLCs), specially programmed, special-purpose hardware, for example, an application-specific integrated circuit (ASIC) or controllers intended for analytical systems. In some embodiments, the controller 170 may be operably connected to or connectable to a user interface constructed and arranged to permit a user or operator to view relevant operational parameters of the system 100, adjust said operational parameters, and/or stop operation of the system 100 as needed. The user interface may include a graphical user interface (GUI) that includes a display configured to be interacted with by a user or service provider and output status information of the system 100.

The controller 170 can include one or more processors typically connected to one or more memory devices, which can comprise, for example, any one or more of a disk drive memory, a flash memory device, a RAM memory device, or other device for storing data. The one or more memory devices can be used for storing programs and data during operation of the system 100. For example, the memory device may be used for storing historical data relating to the parameters over a period. Software, including programming code that implements embodiments of the invention, can be stored on a computer readable and/or writeable nonvolatile recording medium, and then typically copied into the one or more memory devices wherein it can then be executed by the one or more processors. Such programming code may be written in any of a plurality of programming languages, for example, ladder logic, Python, Java, Swift, Rust, C, C#, or C++, G, Eiffel, VBA, or any of a variety of combinations thereof.

As noted above, the system 100 may be designed and configured to perform a method of treating a wastewater having an ammonia concentration that is toxic to anaerobic bacteria, for example, wastewater from a blue hydrogen production plant. The method may include introducing the wastewater into the anaerobic biological treatment system 130 to produce a digestate from the wastewater. The wastewater may have been pre-treated in the solids/liquid separation unit operation 110 such that the wastewater introduced into the anaerobic biological treatment system 130 is supernatant from the solids/liquid separation unit operation 110. At least a portion of the digestate from the anaerobic biological treatment system 130 is introduced into the ammonia recovery/removal sub-system 140 to separate the digestate into removed ammonia and an effluent having a lower ammonia concentration than the digestate. A first portion of the effluent from the ammonia recovery/removal sub-system 140 is introduced into the aerobic biological treatment vessel 160. The wastewater introduced into the anaerobic biological treatment system 130 is diluted by introducing a second portion of the effluent from the ammonia recovery/removal sub-system 140 a point upstream of the anaerobic biological treatment system 130 and/or directly into the anaerobic biological treatment system 130 with the wastewater. The relative flow rates of the first and second portions of the effluent from the ammonia recovery/removal sub-system 140 are regulated to cause the second portion of the effluent and/or the second portion of the digestate to be introduced into the anaerobic biological treatment system 130 in an amount sufficient to mix with the wastewater introduced into the anaerobic biological treatment system 130 and form an anaerobic biological treatment vessel influent having an ammonia concentration less than that of the wastewater and lower than an ammonia concentration that is toxic to anaerobic bacteria in the anaerobic biological treatment system 130.

A sufficient amount of the second portion of the effluent from the ammonia recovery/removal sub-system 140 may be mixed with the wastewater introduced or to be introduced into the anaerobic biological treatment system 130 to form the influent to the anaerobic biological treatment system 130 with an ammonia concentration of less than about 2000 mg/L or less than about 1500 mg/L.

The method may include measuring the concentration of ammonia in one or both of the wastewater or the effluent from the ammonia recovery/removal sub-system 140.

The relative flow rates of the first and second portions of the effluent from the ammonia recovery/removal sub-system 140 may be selected based on at least one of the concentration of ammonia in the wastewater and the concentration of ammonia in the effluent from the ammonia recovery/removal sub-system 140.

Caustic, for example, sodium hydroxide may be introduced into the digestate from the anaerobic biological treatment system 130 upstream of the ammonia recovery/removal sub-system 140. A pH adjustment agent may be introduced into the second portion of the effluent from the second outlet of the ammonia recovery/removal sub-system 140 or the wastewater upstream of the inlet of the anaerobic biological treatment system 130 in an amount and concentration sufficient to maintain a pH of aqueous solution within the anaerobic biological treatment system 130 between about 6.6 and about 8.0.

### Prophetic Example

In one prophetic example, wastewater entering an equalization tank of a system as illustrated in FIG. 1 and treated water exiting the aerobic biological treatment vessel may exhibit the parameters listed in Table 1 below:

TABLE 1
Influent wastewater and treated water parameters

| | Value of Parameter | Value of Parameter |
|---|---|---|
| Parameter | in Wastewater | in treated water |
| Flow Average (m³/d) | 240 | 240 |
| COD (mg/l) | 19,400 | <500 |
| BOD (mg/l) | 12,000 | <50 |
| TOC (mg/l) | 13,200 | — |
| TSS (mg/l) | 2,650 | <50 |
| NH₃—N (mg/l) | 5,300 | <12 |
| FOG (mg/l) | 0 | <15 |
| Cyanide (mg/l) | 0.04 | <0.02 |
| Phenolic Compounds (mg/l) | 0 | <0.4 |
| pH | 3-9 | 6-9 |
| Temperature (° C.) | 35-40 | <40 |

As shown in this prophetic example, embodiments of the systems and methods disclosed herein are expected b=to be effective at significantly reducing concentrations of ammonia, COD, BOD, TOC (total organic content), and TSS (total suspended solids) from wastewater streams such as those generated in blue hydrogen production.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A method of treating a wastewater having an ammonia concentration that is toxic to anaerobic bacteria, the method comprising:
introducing the wastewater into an anaerobic biological treatment vessel to produce a digestate from the wastewater;
introducing the digestate from the anaerobic biological treatment vessel into an ammonia removal sub-system to separate the digestate into removed ammonia and an effluent having a lower ammonia concentration than the digestate;
introducing a first portion of the effluent from the ammonia removal sub-system into an aerobic biological treatment vessel;
diluting the wastewater introduced into the anaerobic biological treatment vessel by introducing a second portion of the effluent from the ammonia removal sub-system into one of a point upstream of the anaerobic biological treatment vessel and into the anaerobic biological treatment vessel with the wastewater; and
regulating relative flow rates of the first and second portions of the effluent from the ammonia removal sub-system to cause the second portion of the effluent to be introduced into the anaerobic biological treatment vessel in an amount sufficient to mix with the wastewater introduced into the anaerobic biological treatment vessel and form an anaerobic biological treatment vessel influent having an ammonia concentration less than that of the wastewater and lower than an ammonia concentration that is toxic to anaerobic bacteria in the anaerobic biological treatment vessel.

2. The method of claim 1, comprising mixing a sufficient amount of the second portion of the effluent from the ammonia removal sub-system with the wastewater introduced into the anaerobic biological treatment vessel to form the influent with an ammonia concentration of less than about 2000 mg/L.

3. The method of claim 2, further comprising measuring a concentration of ammonia in the wastewater.

4. The method of claim 3, further comprising measuring a concentration of ammonia in the effluent from the ammonia removal sub-system.

5. The method of claim 4, further comprising selecting the relative flow rates of the first and second portions of the effluent from the ammonia removal sub-system based on at least one of the concentration of ammonia in the wastewater and the concentration of ammonia in the effluent from the ammonia removal sub-system.

6. The method of claim 1, further comprising introducing caustic into the digestate from the anaerobic biological treatment vessel upstream of the ammonia removal sub-system.

7. The method of claim 6, further comprising introducing a pH adjustment agent into one of the second portion of the effluent from the second outlet of the ammonia removal sub-system and the wastewater upstream of the inlet of the anaerobic biological treatment vessel in an amount and concentration sufficient to maintain a pH of aqueous solution within the anaerobic biological treatment vessel between about 6.6 and about 8.0.

8. The method of claim 1, further comprising obtaining the wastewater from a blue hydrogen production plant.

9. An apparatus for treating a wastewater having an ammonia concentration that is toxic to anaerobic bacteria, the system comprising:
an anaerobic biological treatment vessel having an inlet configured to receive the wastewater and an outlet configured to output digestate from the anaerobic biological treatment vessel;
an ammonia removal sub-system having an inlet configured to receive the digestate from the outlet of the anaerobic biological treatment vessel, a removed ammonia outlet, and an effluent outlet configured to output effluent from the ammonia removal sub-system;
an aerobic biological treatment vessel having an inlet configured to receive a first portion of the effluent from the effluent outlet of the ammonia removal sub-system;
a recycle line configured to direct a second portion of the effluent from the effluent outlet of the ammonia removal sub-system to one of a point upstream of the anaerobic biological treatment vessel and into the anaerobic biological treatment vessel; and
a controller configured to regulate relative flow rates of the first and second portions of the effluent from the ammonia removal sub-system and to cause the second portion of the effluent to be introduced into the anaerobic biological treatment vessel in an amount sufficient to mix with wastewater introduced into the anaerobic biological treatment vessel and form an anaerobic biological treatment vessel influent having an ammonia concentration that is less than that of the wastewater and lower than an ammonia concentration that is toxic to anaerobic bacteria in the anaerobic biological treatment vessel.

10. The system of claim 9, wherein the controller is configured to cause the sufficient amount of the second portion of the effluent from the outlet of the ammonia removal sub-system to be mixed with the wastewater introduced into the anaerobic biological treatment vessel to form the influent with an ammonia concentration of less than about 2000 mg/L.

11. The system of claim 10, further comprising an ammonia concentration sensor configured to measure a concentration of ammonia in the wastewater and provide an indication of the concentration of ammonia in the wastewater to the controller.

12. The system of claim 11, wherein the controller is further configured to determine the relative flow rates of the first and second portions of the effluent from the ammonia removal sub-system based at least in part on the indication of the concentration of ammonia in the wastewater.

13. The system of claim 11, further comprising a second ammonia concentration sensor configured to measure a concentration of ammonia in the effluent from the ammonia removal sub-system and provide an indication of the concentration of ammonia in the effluent from the ammonia removal sub-system to the controller.

14. The system of claim 13, wherein the controller is further configured to determine the relative flow rates of the first and second portions of the effluent from the ammonia removal sub-system based at least in part on the indication of the concentration of ammonia in the wastewater and the indication of the concentration of ammonia in the effluent from the ammonia removal sub-system.

15. The system of claim 9, wherein the controller is further configured to set the relative flow rates of the first and second portions of the effluent from the ammonia removal sub-system such that a ratio between an amount of the second portion of the effluent from the ammonia removal sub-system and an amount of influent wastewater introduced into the anaerobic biological treatment vessel is between 0.5 and 10.

16. The system of claim 9, wherein the ammonia removal sub-system includes an ammonia stripper.

17. The system of claim 16, further comprising a source of caustic configured to introduce caustic into the digestate from the outlet of the anaerobic biological treatment vessel upstream of the inlet of the ammonia removal sub-system.

18. The system of claim 17, further comprising a source of pH adjustment agent configured to introduce the pH adjustment agent into one of the second portion of the effluent from the outlet of the ammonia removal sub-system and/or the wastewater upstream of the inlet of the anaerobic biological treatment vessel.

19. The system of claim 18, wherein the controller is further configured to regulate addition of the pH adjustment agent into the one of the second portion of the effluent from the outlet of the ammonia removal sub-system or the wastewater to maintain a pH of aqueous solution within the anaerobic biological treatment vessel between about 6.6 and about 8.0.

20. The system of claim 9, further comprising an equalization tank upstream of the anaerobic biological treatment vessel.

21. The system of claim 9, further comprising a return activated sludge recycle line configured to recycle activated sludge from a sludge outlet of the aerobic biological treatment vessel to the inlet of the aerobic biological treatment vessel.

22. The system of claim 9, further comprising a return activated sludge recycle line configured to recycle activated sludge from a sludge outlet of the aerobic biological treatment vessel to the inlet of the anaerobic biological treatment vessel.

23. The system of claim 9, wherein the aerobic biological treatment vessel includes a membrane bioreactor.
